(19) United States
(12) Patent Application Publication
(10) Pub. No.: US 2019/0278285 A1
(43) Pub. Date: Sep. 12, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Dan Umeda, Wako-shi (JP); Akihiro Toda, Wako-shi (JP); Yugo Ueda, Wako-shi (JP)

(21) Appl. No.: 16/291,030

(22) Filed: Mar. 4, 2019

(30) Foreign Application Priority Data
Mar. 7, 2018 (JP) 2018-041269

(51) Int. Cl. G05D 1/02; G05D 1/00

(52) U.S. Cl. CPC G05D 1/0223; G06F 16/29; G05D 1/0088

(57) ABSTRACT

A vehicle control device includes: a recognizer (120) configured to recognize a surrounding situation of an own vehicle; and a driving controller (140 or 160) configured to control acceleration, deceleration, and steering of the own vehicle based on a recognition result of the recognizer and allowing the own vehicle to overtake a plurality of preceding vehicles in front of the own vehicle in an own lane in which the own vehicle is present when the overtaking by the own vehicle is allowed, the plurality of preceding vehicles are congested in a row and a position of the foremost preceding vehicle among the plurality of preceding vehicles is closer to the own vehicle than a predetermined position to which the own vehicle is scheduled to travel.

### CROSS-REFERENCE TO RELATED APPLICATION

This application claims priority to and benefit of Japanese Patent Application No. 2018-041269, filed on Mar. 7, 2018, which is hereby incorporated by reference in its entirety.

### BACKGROUND

### Field of the Invention

The present invention relates to a vehicle control device, a vehicle control method, and a storage medium.

### Description of Related Art

In recent years, studies for automatically controlling driving of vehicles (hereinafter referred to as automatic driving) have been conducted. In relation with the studies, a technology for causing a navigation device to obtain a rear end of congestion in a right-turn lane or a left-turn lane and guiding a change in the lane in advance so that an own vehicle arrives at the rear end of the congestion when vehicles are congested in a movement direction of the own vehicle has become known (for example, see Japanese Unexamined Patent Application, First Publication No. 2009-25235).

### SUMMARY

Incidentally, at an uncongested spot in which a head of congestion does not reach a position of a right or left turn, a vehicle can pass through the congested spot fast when the vehicle overtakes the congestion from an adjacent lane and subsequently returns to its original lane. However, in the technology of the related art, it is assumed that a vehicle may not determine whether to line up at the rear end of a vehicle in front of it or to overtake the vehicle in front of it.

The present invention is devised in view of such circumstances and one object of the present invention is to provide a vehicle control device, a vehicle control method, and a storage medium capable of determining whether to overtake a vehicle in front depending on a surrounding situation.

The vehicle control system, the vehicle control method, and the storage medium according to aspects of the present invention adopt the following configurations.

(1) According to an aspect of the present invention, there is provided a vehicle control device including: a recognizer configured to recognize a surrounding situation of an own vehicle; and a driving controller configured to control acceleration, deceleration, and steering of the own vehicle based on a recognition result of the recognizer and allowing the own vehicle to overtake a plurality of preceding vehicles in front of the own vehicle in an own lane in which the own vehicle is present when the own vehicle is allowed to perform overtaking, the plurality of preceding vehicles are congested in a row, and a position of the foremost preceding vehicle among the plurality of preceding vehicles is closer to the own vehicle than a predetermined position to which the own vehicle is scheduled to travel.

(2) In the foregoing (1) aspect, the predetermined position may be a position at which the own vehicle overtakes the plurality of preceding vehicles congested in a row by changing a lane and then preferably returns to the original lane to travel along a route in which the own vehicle is scheduled to travel.

(3) In the foregoing (2) aspect, the predetermined position may be a position in front of a position at which a plurality of lanes are joined into one side lane, and is a position in a lane which is a main lane after the joining.

(4) In the foregoing (2) or (3) aspect, the predetermined position may be a position in front of an intersection at which an instruction to turn right is given along the scheduled route and a position in a lane in which a right turn is possible, or a position in front of an intersection at which an instruction to turn left is given along the scheduled route and a position in a lane in which a left turn is possible.

(5) In the foregoing (2) or (3) aspect, the driving controller may be configured to control a speed and steering of the own vehicle to move the own vehicle from a middle of a lane to a position biased to a right or left mark line side in a lane width direction. The recognizer may be configured to recognize a position of the foremost preceding vehicle after the own vehicle is moved to the position biased from the middle of the lane by the driving controller.

(6) In the foregoing (5) aspect, the driving controller may be configured to determine whether the position of the foremost preceding vehicle recognized by the recognizer is in front of the predetermined position.

(7) According to another aspect of the present invention, there is provided a vehicle control method causing a computer to perform: recognizing a surrounding situation of an own vehicle; and controlling acceleration, deceleration, and steering of the own vehicle based on a recognition result and allowing the own vehicle to overtake a plurality of preceding vehicles in front of the own vehicle in an own lane in which the own vehicle is present when the overtaking by the own vehicle is allowed, the plurality of preceding vehicles are congested in a row, and a position of the foremost preceding vehicle among the plurality of preceding vehicles is closer to the own vehicle than a predetermined position to which the own vehicle is scheduled to travel.

(8) According to still another aspect of the present invention, there is provided a storage medium causing a computer to perform: a process of recognizing a surrounding situation of an own vehicle; and a process of controlling acceleration, deceleration, and steering of the own vehicle based on a recognition result and allowing the own vehicle to overtake a plurality of preceding vehicles in front of the own vehicle in an own lane in which the own vehicle is present when the overtaking by the own vehicle is allowed, the plurality of preceding vehicles are congested in a row, and a position of the foremost preceding vehicle among the plurality of preceding vehicles is closer to the own vehicle than a predetermined position to which the own vehicle is scheduled to travel.

According to (1) to (7), it is possible to determine whether to overtake a vehicle in front depending on a surrounding situation.

### BRIEF DESCRIPTION OF THE DRAWINGS

FIG. 1 is a diagram showing a configuration of a vehicle system 1 using a vehicle control device according to an embodiment.

FIG. 2 is a diagram showing functional configurations of a first controller 120 and a second controller 160.

FIG. 3 is a flowchart showing an example of a flow of a series of processes by an automatic driving control device 100 according to the embodiment.

FIG. 4 is a diagram showing an example of a scenario in which a vehicle overtakes a parked vehicle which is an example of a preceding vehicle which is an overtaking target.

FIG. 5 is a diagram showing a first scenario in which a vehicle overtakes a congestion vehicle queue up to a predetermined position SP1.

FIG. 6 is a diagram showing a second scenario in which the vehicle does not overtake the congestion vehicle queue up to the predetermined position SP1.

FIG. 7 is a diagram showing a third scenario in which the vehicle overtakes a congestion vehicle queue up to a predetermined position SP2.

FIG. 8 is a diagram showing a fourth scenario in which the vehicle does not overtake the congestion vehicle queue up to the predetermined position SP2.

FIG. 9 is a diagram showing a fifth scenario in which the vehicle overtakes a congestion vehicle queue up to a predetermined position SP3.

FIG. 10 is a diagram showing a sixth scenario in which the vehicle does not overtake the congestion vehicle queue up to the predetermined position SP3.

FIG. 11 is a diagram showing a seventh scenario in which the vehicle overtakes a congestion vehicle queue up to a predetermined position SP4.

FIG. 12 is a diagram showing an eighth scenario in which the vehicle does not overtake the congestion vehicle queue up to the predetermined position SP4.

FIG. 13 is a diagram showing an example of a hardware configuration of the automatic driving control device according to the embodiment.

### DESCRIPTION OF EMBODIMENTS

Hereinafter, embodiments of a vehicle control device and a storage medium according to the present invention will be described with reference to the drawings. Hereinafter, a case in which left-hand traffic regulations are applied will be described. When right-hand traffic regulations are applied, the right and left may be switched.

### Embodiment

### [Overall Configuration]

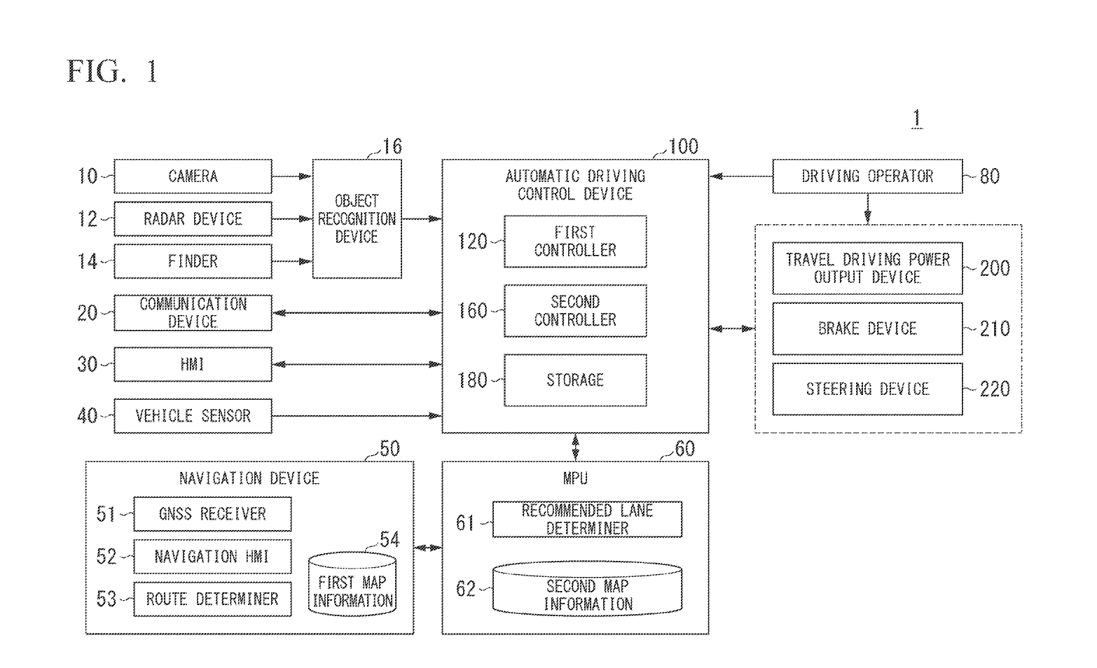

FIG. 1 is a diagram showing a configuration of a vehicle system 1 using a vehicle control device according to an embodiment. A vehicle in which the vehicle system 1 is mounted (hereinafter referred to as an own vehicle M) is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automatic driving control device 100, a travel driving power output device 200, a brake device 210, and a steering device 220. The devices and units are connected to each other via a multiplex communication line such as a controller area network (CAN) communication line, a serial communication line, or a wireless communication network. The configuration shown in FIG. 1 is merely exemplary, a part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of the own vehicle M. In the case of forward imaging, the camera 10 is mounted on an upper portion of a front windshield, a rear surface of a rearview mirror, or the like. For example, the camera 10 repeatedly images the periphery of the own vehicle M periodically. The camera 10 may be a stereo camera.

The radar device 12 radiates radio waves such as millimeter waves to the periphery of the own vehicle M and detects radio waves (reflected waves) reflected from an object to detect at least a position (a distance and an azimuth) of the object. The radar device 12 is mounted on any portion of the own vehicle M. The radar device 12 may detect a position and a speed of an object in conformity with a frequency modulated continuous wave (FM-CW) scheme.

The finder 14 is a light detection and ranging (LIDAR). The finder 14 emits light to the periphery of the own vehicle M and measures scattered light. The finder 14 detects a distance to a target based on a time from light emission and light reception. The emitted light is, for example, a pulsed laser beam. The finder 14 is mounted on any portion of the own vehicle M.

The object recognition device 16 performs a sensor fusion process on detection results of some or all of the camera 10, the radar device 12, and the finder 14 and recognizes a position, a kind, a speed, and the like of an object. The object recognition device 16 outputs a recognition result to the automatic driving control device 100. The object recognition device 16 may output the detection results of the camera 10, the radar device 12, and the finder 14 without change to the automatic driving control device 100. The object recognition device 16 may be omitted from the vehicle system 1.

The communication device 20 communicates with other vehicles around the own vehicle M using, for example, a cellular network, a Wi-Fi network, Bluetooth (registered trademark), dedicated short range communication (DSRC), or the like or communicates with various server devices via wireless base stations.

The HMI 30 suggests various kinds of information to occupants of the own vehicle M and receives input manipulations by the occupants. The HMI 30 includes various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects an angular velocity around a vertical axis, and an azimuth sensor that detects a direction of the own vehicle M.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory.

The GNSS receiver 51 specifies a position of the own vehicle M based on signals received from GNSS satellites. The position of the own vehicle M may be specified or complemented by an inertial navigation system (INS) using an output of the vehicle sensor 40.

The navigation HMI 52 includes a display device, a speaker, a touch panel, and a key. The navigation HMI 52 may be partially or entirely common to the above-described HMI 30.

The route determiner 53 decides, for example, a route from a position of the own vehicle M specified by the GNSS receiver 51 (or any input position) to a destination input by an occupant using the navigation HMI 52 (hereinafter referred to as a map route) with reference to the first map information 54. The first map information 54 is, for example, information in which a road model is expressed by links indicating roads and nodes connected by the links. The first map information 54 may include curvatures of roads and point of interest (POI) information. The map route is output to the MPU 60.

The navigation device 50 may perform route guidance using the navigation HMI 52 based on a map route. The navigation device 50 may be realized by, for example, a function of a terminal device such as a smartphone or a tablet terminal possessed by the occupant. The navigation device 50 may transmit a current position and a destination to a navigation server via the communication device 20 to acquire the same route as a map route from the navigation server.

The MPU 60 includes, for example, a recommended lane determiner 61 and retains second map information 62 in a storage device such as an HDD or a flash memory. The recommended lane determiner 61 divides a map route provided from the navigation device 50 into a plurality of blocks (for example, divides the map route in a vehicle movement direction for each 100 [m]) and decides a recommended lane for each block with reference to the second map information 62. The recommended lane determiner 61 decides in which lane the own vehicle M travels from the left. When there is a branching spot on a map route, the recommended lane determiner 61 decides a recommended lane so that the own vehicle M can travel along a reasonable route for traveling to a branching destination. The map route or the route indicated by the recommended lane is an example of a “scheduled route.”

The second map information 62 is map information with higher precision than the first map information 54. The second map information 62 includes, for example, information regarding the middles of lanes or information regarding boundaries of lanes and information regarding kinds of lanes. The second map information 62 may include road information, traffic regulation information, address information (address and postal number), facility information, and telephone number information. The second map information 62 may frequently be updated when the communication device 20 communicates with another device.

The driving operator 80 includes, for example, an accelerator pedal, a brake pedal, a shift lever, a steering wheel, a steering variant, a joystick, and other manipulators. A sensor that detects whether there is a manipulation or a manipulation amount is mounted on the driving operator 80. A detection result is output to the automatic driving control device 100 or some or all of the travel driving power output device 200, the brake device 210, and the steering device 220.

The automatic driving control device 100 includes, for example, a first controller 120, a second controller 160, and a storage 180. Each of the first controller 120 and the second controller 160 is realized, for example, by causing a processor such as a central processing unit (CPU) to execute a program (software). Some or all of these constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in the storage 180 of the automatic driving control device 100 or may be stored in a removable storage medium such as a DVD or a CD-ROM to be installed in the storage 180 when the storage medium is mounted in the drive device.

The storage 180 is realized by, for example, an HDD, a flash memory, an electrically erasable programmable read only memory (EEPROM), a read only memory (ROM), or a random access memory (RAM). The storage 180 stores, for example, a program read and executed by a processor.

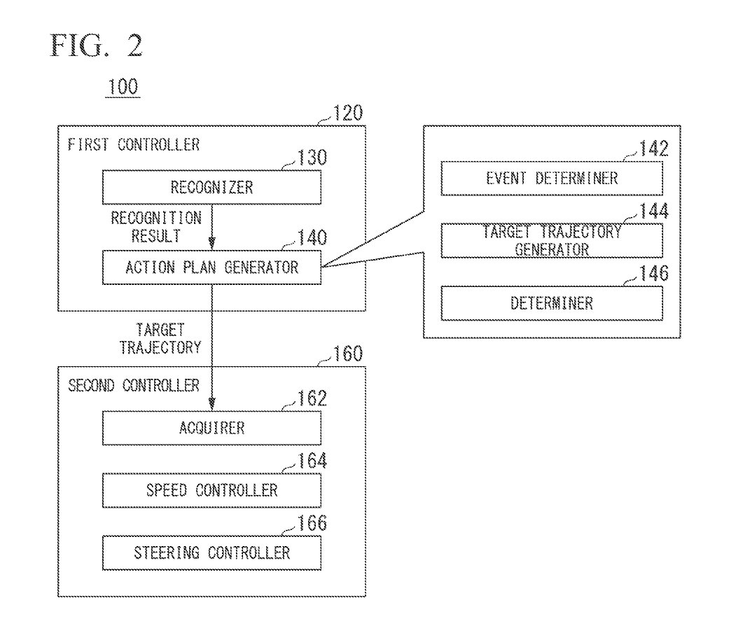

FIG. 2 is a diagram showing functional configurations of the first controller 120 and the second controller 160. The first controller 120 includes, for example, a recognizer 130 and an action plan generator 140. The first controller 120 concurrently realizes, for example, a function by artificial intelligence (AI) and a function by a pre-given model. For example, an “intersection recognition” function may be realized by concurrently performing recognition of an intersection by deep learning or the like and recognition based on a pre-given condition (there is a sign, a road sign, and the like for which pattern matching is possible) and scoring both the both for comprehensive evaluation. In this way, reliability of automatic driving is guaranteed.

The recognizer 130 recognizes surrounding situations of the own vehicle M based on information input from the camera 10, the radar device 12, and the finder 14 via the object recognition device 16. Specifically, the recognizer 130 recognizes situations such as a position, a speed, acceleration, and the like of objects around the own vehicle M. The position of an object is recognized as, for example, a position on absolute coordinates for which a representative point (the center of gravity, a center of a driving shaft, or the like) of the own vehicle M is set as the origin and is used for control. The position of an object may be expressed as a representative point of the center of gravity, a corner, or the like of the object or may be represented in an expressed region. A “state” of an object may include acceleration or jerk of the object or an “action state” (for example, whether to change a lane or attempt to change a lane).

For example, the recognizer 130 recognizes a lane (traveling lane) in which the own vehicle M is traveling. For example, the recognizer 130 recognizes a traveling lane by comparing patterns of road mark lines (for example, arrangement of continuous lines and broken lines) obtained from the second map information 62 with patterns of road mark lines around the own vehicle M recognized from images captured by the camera 10. The recognizer 130 may recognize a traveling lane by mainly recognizing boundaries (road boundaries) including road mark lines or shoulders, curbstones, median strips, and guardrails without being limited to road mark lines. In this recognition, the position of the own vehicle M acquired from navigation device 50 or a process result by INS may be added. The recognizer 130 recognizes temporary stop lines, obstacles, red signals, toll gates, other road events.

The recognizer 130 recognizes a position or an attitude of the own vehicle M with respect to the traveling lane when the recognizer 130 recognizes the traveling lane. For example, the recognizer 130 may recognize a separation from the middle of a lane of a reference point of the own vehicle M and an angle formed with a line extending along the middle of a lane in the traveling direction of the own vehicle M as a relative position and attitude of the own vehicle M to the traveling lane. Instead of this, the recognizer 130 may recognize a position or the like of the reference point of the own vehicle M with respect to a side end portion (a road mark line or a road boundary) of any traveling lane as the relative position of the own vehicle M to the traveling lane.

The action plan generator 140 includes, for example, an event determiner 142, a target trajectory generator 144, and a determiner 146. The event determiner 142 decides an event of automatic driving along a route in which the recommended lane is decided. The event is information that regulates a traveling aspect of the own vehicle M.

The event includes, for example, a constant speed traveling event for allowing the own vehicle M to travel along the same lane at a steady speed, a tracking travel event for allowing the own vehicle M to track another vehicle which is in front of the own vehicle M (hereinafter referred to as a preceding vehicle), a lane changing event for allowing the own vehicle M to change a lane from an own lane to an adjacent lane, a branching event for allowing the own vehicle M to branch from a branching spot of a road to a destination side lane, a joining event for allowing the own vehicle M to join from a joining spot to a main lane, and a takeover event for ending the automatic driving to switch the automatic driving to manual driving. The “tracking” is, for example, a traveling aspect for allowing a relative distance (inter-vehicle distance) between the own vehicle M and a preceding vehicle to be maintained constantly. The event may include, for example, an overtaking event for temporarily changing the lane of the own vehicle M to an adjacent lane, overtaking the preceding vehicle in the adjacent lane, and changing the lane to the original lane again and an avoiding event for allowing the own vehicle M to perform at least one of braking and steering to avoid approach of an obstacle.

The event determiner 142 may change the event which has already been decided to another event or newly decide an event in accordance with a surrounding situation recognized by the recognizer 130 when the own vehicle M is traveling.

The target trajectory generator 144 generates a future target trajectory along which the own vehicle M is allowed to automatically travel in accordance with a traveling aspect defined by the event (irrespective of a manipulation by a driver) so that the own vehicle M can travel along the recommended lane decided by the recommended lane determiner 61 in principle and further cope with a surrounding situation when the own vehicle M is traveling. The target trajectory includes, for example, a position element for deciding a future position of the own vehicle M and a speed element for deciding a future speed or the like of the own vehicle M.

For example, the target trajectory generator 144 decides a plurality of spots (trajectory points) at which the own vehicle M is scheduled to arrive in sequence as the position element of the target trajectory. The trajectory points are spots at which the own vehicle M is scheduled to arrive for each predetermined traveling distance (for example, about several [m]). The predetermined traveling distance may be calculated in accordance with, for example, a distance along the road at the time of advancing along the route.

The target trajectory generator 144 decides a target speed and target acceleration as the speed element of the target trajectory for each predetermined sampling time (for example, about 0 decimal point [sec]). The trajectory points may be positions at which the own vehicle M is scheduled to arrive at the sampling time for each predetermined sampling time. In this case, the target speed or the target acceleration is decided in accordance with the sampling time and an interval of the trajectory points. The target trajectory generator 144 outputs information indicating the generated target trajectory to the second controller 160.

The determiner 146 determines whether a relative speed RS of the own vehicle M to a speed of the preceding vehicle is equal to or greater than a predetermined speed V1. The preceding vehicle is a vehicle that is traveling in front of the own vehicle M in the own lane in a state in which there are no other vehicles between the own vehicle M and the preceding vehicle. The predetermined speed V1 is, for example, a speed in about tens of [km/h].

When the determiner 146 determines that the relative speed RS is equal to or greater than the predetermined speed V1 and a change in the lane is possible depending on a situation of other vehicles in an adjacent lane, the event determiner 142 decides to overtake the preceding vehicle. A scenario in which it is determined that the change in the lane is possible depending on the situation of the other vehicles in the adjacent lanes is a scenario in which there are no other vehicles traveling in parallel to the own vehicle M in the adjacent lanes, a collision spare time TTC (time-to-collision) of the own vehicle M and the preceding vehicle which is in an adjacent lane in front of the own vehicle M is greater than a threshold Th1, and a collision spare time TTC of the own vehicle M and a rear vehicle which is an adjacent lane in back of the own vehicle M is greater than a threshold Th2. The threshold Th1 is derived, for example, by dividing a distance between a front vehicle and an extension line imaginarily extending the front end of the own vehicle M to the side of the adjacent lane by a relative speed of the own vehicle M to the front vehicle. The threshold Th2 is derived, for example, by dividing a distance between a rear vehicle and an extension line imaginarily extending the rear end of the own vehicle M to the side of the adjacent lane by a relative speed of the own vehicle M to the rear vehicle. The thresholds Th1 and Th2 may be the same value or may be different values.

The determiner 146 determines overtaking stop conditions to be described below and the event determiner 142 stops the overtaking when the overtaking stop conditions are satisfied. The overtaking stop conditions are that (A) a plurality of preceding vehicles in front of the own vehicle M in the own lane are congested in a row and (B) the position of the foremost traveling vehicle among the plurality of preceding vehicles is a position which is more away from the own vehicle M than a predetermined position at which the own vehicle M is scheduled to travel. The congested state is, for example, a state in which a speed of each of the plurality of preceding vehicles in front of the own vehicle M in the own lane is equal to or less than a predetermined speed V2 and an inter-vehicle distance between the plurality of preceding vehicles is within a predetermined inter-vehicle distance. The predetermined speed V2 is, for example, a speed of about 20 [km/h]. The predetermined inter-vehicle distance is, for example, a distance of about several [m].

The predetermined position is a preferable position at which the own vehicle returns to the original lane after a group of vehicles is overtaken by changing the lane to travel along the target trajectory. The preferable position is, for example, (1) a position which is ahead by a predetermined distance D1 in front of a position at which a plurality of lanes are joined into one side lane and a position in a lane which is a main lane after the joining (hereinafter referred to as a predetermined position SP1: described later in the drawing), (2) a position which is ahead by a predetermined distance D2 in front of an intersection at which an instruction to turn right is given along the target route and a position in a lane in which a right turn is possible (hereinafter referred to as a predetermined position SP2), (3) a position which is ahead by a predetermined distance D3 in front of an intersection at which an instruction to turn left is given along the target route and a position in a lane in which a left turn is possible (hereinafter referred to as a predetermined position SP3), and (4) a position at which is ahead by a predetermined distance D4 from a junction at which an instruction to change a course to the branched lane along the target trajectory and a position on a lane in which the own vehicle can travel to the branched lane (hereinafter referred to as a predetermined position SP4). The predetermined distance D1 and the predetermined distance D4 are each, for example, a distance of about several [m] to tens of [m] and the predetermined distance D2 and the predetermined distance D3 are each, for example, a distance of about tens of [m]. In the following description, when the predetermined positions SP1 to SP4 are not distinguished from each other, the predetermined positions SP1 to SP4 are referred to as the predetermined positions SP.

When the determiner 146 determines that the relative speed RS is equal to or greater than the predetermined speed V1 and the overtaking stop conditions are not satisfied, the event determiner 142 changes an event in which a section in which the own vehicle M is currently traveling is planned to an overtaking event. In this case, the target trajectory generator 144 generates a target trajectory in accordance with the overtaking event. When the determiner 146 determines that the relative speed RS is not equal to or greater than the predetermined speed V1 or determines that the relative speed RS is equal to or greater than the predetermined speed V1 and the overtaking stop conditions are satisfied (that is, the own vehicle does not overtake the preceding vehicle), the event determiner 142 maintains the current event without changing the event in which the section in which the own vehicle M is currently traveling is planned to the overtaking event. For example, the target trajectory generator 144 generates a target trajectory for traveling at a steady speed or tracking the preceding vehicle.

When the determiner 146 determines that the relative speed RS is equal to or greater than the predetermined speed V1 or determines that the overtaking stop conditions are not satisfied, the event determiner 142 further determines whether time-to-collision (TTC) with each of the other vehicles on an adjacent lane which is a lane of a lane changing destination at the time of the overtaking is equal to or greater than a predetermined time. When the determiner 146 determines that the TTC with each of the other vehicles on the adjacent lane is equal to or greater than the predetermined time, the event determiner 142 changes the current event to the overtaking event. When the determiner 146 determines that the TTC with each of the other vehicles on the adjacent lane is less than the predetermined time, the event determiner 142 maintains the current event. In this way, the event determiner 142 may set conditions other than the above-described overtaking stop conditions as conditions for prohibiting or stopping the overtaking.

The second controller 160 controls the travel driving power output device 200, the brake device 210, and the steering device 220 so that the own vehicle M passes along the target trajectory generated by the target trajectory generator 144 on a scheduled time.

The second controller 160 includes, for example, an acquirer 162, a speed controller 164, and a steering controller 166. The second controller 160 and the action plan generator 140 are examples of a “driving controller.”

The acquirer 162 acquires information regarding the target trajectory (trajectory points) generated by the target trajectory generator 144 and stores the information in a memory of the storage 180.

The speed controller 164 controls one or both of the travel driving power output device 200 and the brake device 210 based on a speed element (for example, a target speed or target acceleration) included in the target trajectory stored in the memory.

The steering controller 166 is configured to control the steering device 220 in accordance with a position element (for example, a curvature indicating the degree of bend of the target trajectory or the like) included in the target trajectory stored in the memory.

Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on separation from the target trajectory in combination.

The travel driving power output device 200 outputs a travel driving force (torque) for traveling the vehicle to a driving wheel. The travel driving power output device 200 includes, for example, an internal combustion, a combination of an electric motor and a transmission, and a power electronic control unit (ECU) controlling these units. The power ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in accordance with an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

### [Process Flow]

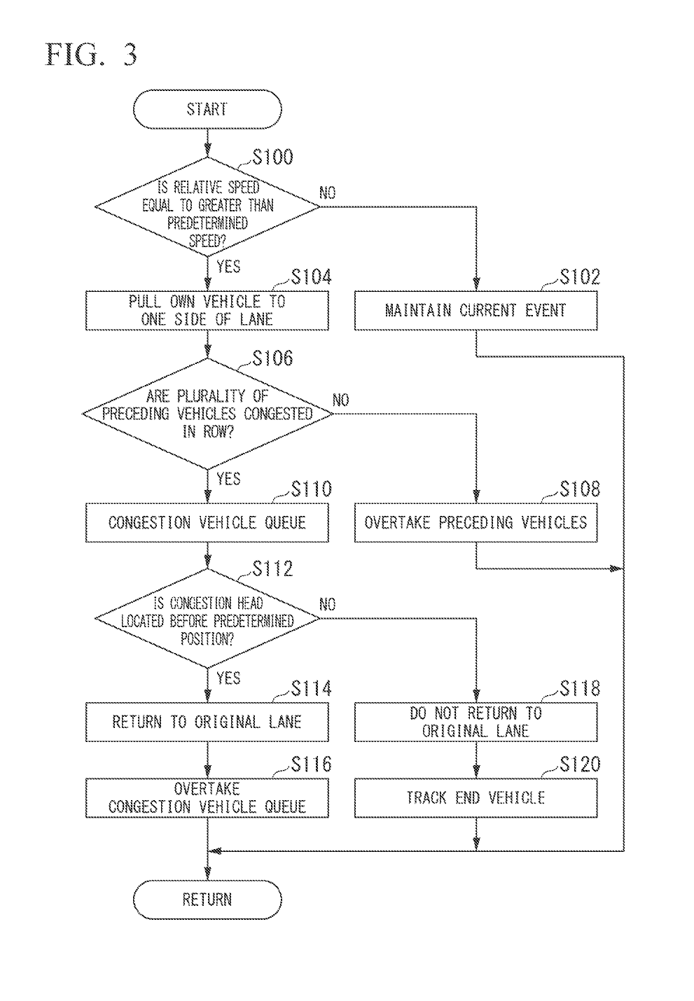

Hereinafter, a flow of a series of processes by the automatic driving control device 100 according to the embodiment will be described with reference to a flowchart. FIG. 3 is a flowchart showing an example of a flow of a series of processes by the automatic driving control device 100 according to the embodiment. The processes of the flowchart are repeatedly performed, for example, at a predetermined period.

The determiner 146 first determines whether a preceding vehicle is present based on a recognition result of the recognizer 130 and the relative speed RS is equal to or greater than the predetermined speed V1 (step S100).

When the determiner 146 determines that no preceding vehicle is present or a preceding vehicle is present and the relative speed RS is less than the predetermined speed V1, the event determiner 142 maintains the current event (step S102).

When the determiner 146 determines that the preceding vehicle is present and the relative speed RS is equal to or greater than the predetermined speed V1, the target trajectory generator 144 generates a target trajectory in which the own vehicle M is separated from the middle of the own lane to the left side or the right side by a given distance in the vehicle width direction (step S104). Thus, since the camera 10, the radar device 12, and the finder 14 detects surrounding objects from different viewpoints, the recognizer 130 easily recognizes situation of the more front side of the preceding vehicle.

Subsequently, the determiner 146 determines whether a plurality of preceding vehicles in front of the own vehicle M in the own lane are congested in a row (step S106).

When the determiner 146 determines that the plurality of preceding vehicles are not congested in a row in front of the own vehicle M in the own lane, the event determiner 142 changes an event planned in the current section to the overtaking event and the target trajectory generator 144 generates a target trajectory for overtaking the preceding vehicles based on the overtaking event (step S108).

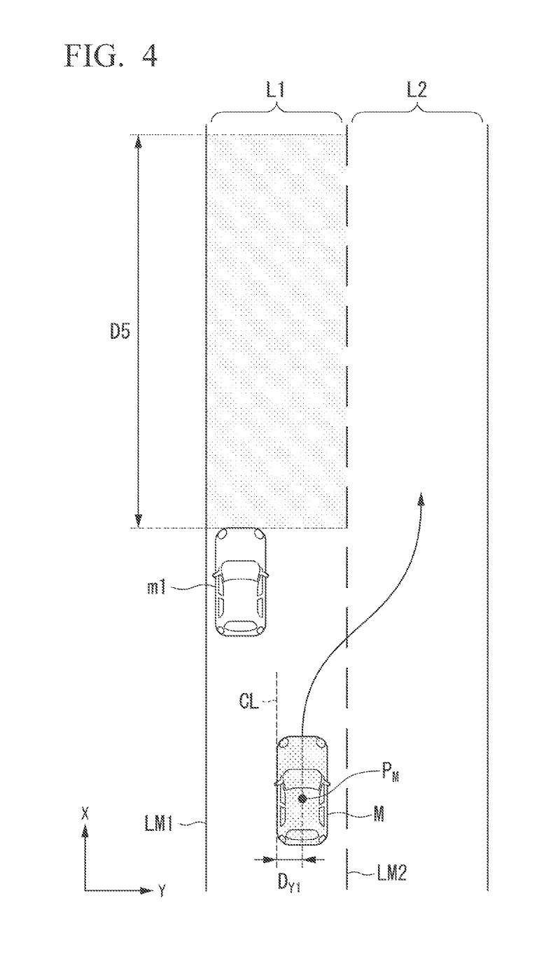

FIG. 4 is a diagram showing an example of a scenario in which the own vehicle overtakes a parked vehicle which is an example of a preceding vehicle which is an overtaking target. In the drawing, m1 indicates a parked vehicle, L1 indicates the own lane, and L2 indicates an adjacent lane. Of two mark lines for marking the own lane L1, LM1 indicates a left mark line in the traveling direction of the own vehicle M. Of two mark lines for marking the own lane L1, LM2 indicates a right mark line in the traveling direction of the own vehicle M. As shown, an X direction is the traveling direction of the own vehicle M and a Y direction is a road width direction.

In the shown example, through the process of step S104, the automatic driving control device 100 pulls the own vehicle M toward the mark line LM2 (the right side) so that a reference point P_{M} of the own vehicle M is separated from a middle CL of the own vehicle L1 to the mark line LM1 by a given distance D_{Y1} in the vehicle width direction Y, and thus it is easier for the recognizer 130 to recognize the more front side of the parked vehicle m1. Since a plurality of preceding vehicles are not congested in a row within a predetermined distance D5 in front of the parked vehicle m1, the event determiner 142 plans an overtaking event. As a result, the own vehicle M overtakes the parked vehicle ml by temporarily changing the lane to the adjacent lane L2.

Conversely, when the determiner 146 determines that the plurality of preceding vehicles are congested in a row in front of the own vehicle M in the own lane, the determiner 146 determines that a vehicle group including the preceding vehicle and the plurality of preceding vehicles in front of the preceding vehicle is a queue of the vehicles formed due to traffic congestion (hereinafter referred to as a congestion vehicle queue) (step S110).

Subsequently, the determiner 146 determines whether the position of a forefront vehicle m_{TOP} of (B) the congestion vehicle queue is closer to the own vehicle M than a predetermined position SP to which the own vehicle M is scheduled to travel in the traveling direction of the own vehicle M on a map on which the first map information 54 and the second map information 62 are shown (step S112).

For example, when the predetermined position SP is in a road on which the own vehicle M is traveling on the map on which the first map information 54 and the second map information 62 are shown, the determiner 146 converts a distance to the forefront vehicle m_{TOP} of the congestion vehicle queue recognized by the recognizer 130 (that is, a length of the congestion vehicle queue) into a scale of the map and specifies a distance-separated spot obtained by converting the distance into the scale from the position of the own vehicle M on the map as the position of the forefront vehicle m_{TOP}.

Then, the determiner 146 compares the predetermined position SP, the position of the forefront vehicle m_{TOP}, and the position of the own vehicle M on the map and determines that the forefront vehicle m_{TOP} of the congestion vehicle queue is located at a position more away from the own vehicle M than the predetermined position SP or the forefront vehicle m_{TOP} of the congestion vehicle queue is located at a position closer to the own vehicle M than the predetermined position SP.

When the determiner 146 determines that the forefront vehicle m_{TOP} of the congestion vehicle queue is located at the position closer to the own vehicle M than the predetermined position SP, that is, the overtaking stop conditions are not satisfied, the determiner 146 determines that the own vehicle M can overtake the congestion vehicle queue in the adjacent lane and can then return to the original lane before the predetermined position SP without obstructing traveling of other vehicles traveling around (step S114).

Subsequently, the event determiner 142 changes the event planned in the current section to the overtaking event and the target trajectory generator 144 generates a target trajectory for overtaking the congestion vehicle queue based on the overtaking event. In response to this, the second controller 160 allows the own vehicle M to temporarily change to the adjacent lane, overtake the congestion vehicle queue in the adjacent lane, and then change to the original lane again by controlling the speed and steering of the own vehicle M based on the target trajectory (step S116).

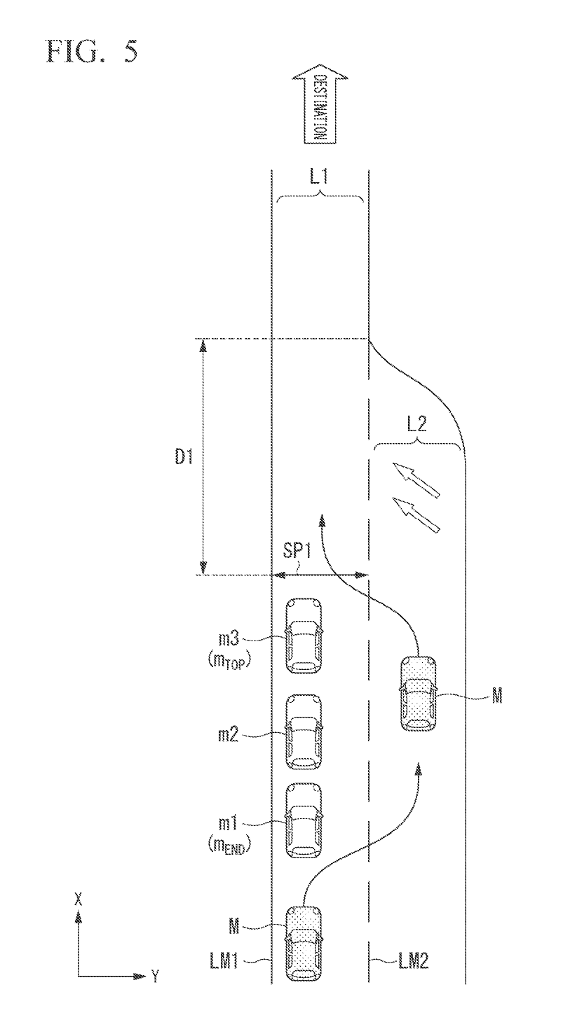

FIG. 5 is a diagram showing a first scenario in which the own vehicle overtakes a congestion vehicle queue up to a predetermined position SP1. In the drawing, m1 to m3 indicates other vehicles forming a congestion vehicle queue, L1 indicates the own lane, and L2 indicates an adjacent lane. L1 and L2 are joined and L1 between L1 and L2 is main lane after the joining. Of the vehicles m1 to m3 forming the congestion vehicle queue, the vehicle m3 is the forefront vehicle m_{TOP} and the vehicle m1 is an end vehicle m_{END} of the congestion vehicle queue. In the shown example, the position of the forefront vehicle m_{TOP} of the congestion vehicle queue is closer to the own vehicle M than the predetermined position SP1 in the traveling direction X. In this case, when the own vehicle M overtakes the congestion vehicle queue in the adjacent lane and then returns to the original lane before the predetermined position SP1, the own vehicle M can travel smoothly without temporarily stopping near the predetermined position SP1. Accordingly, the determiner 146 determines that the own vehicle M can overtake the congestion vehicle queue in front of the own vehicle M in the adjacent lane and then can return to the original lane again. In response to this, the event determiner 142 plans the overtaking event, the target trajectory generator 144 generates a target trajectory in accordance to the overtaking event, and the second controller 160 allows the own vehicle M to overtake the congestion vehicle queue by controlling the speed and steering of the own vehicle M based on the target trajectory.

Conversely, when the determiner 146 determines that the forefront vehicle m_{TOP} of the congestion vehicle queue is located at a position more away from the own vehicle M than the predetermined position SP (that is, the overtaking stop conditions are satisfied) through the process of step S112, the determiner 146 determines that the own vehicle M can overtake the congestion vehicle queue in the adjacent lane and then may not return to the original lane again without obstructing traveling of other vehicles traveling around (step S118).

Subsequently, when the event planned in the current section is not the tracking travel event, the event determiner 142 changes the event to the tracking travel event. When the event planned in the current section is the tracking travel event, the event determiner 142 maintains the event without change. The target trajectory generator 144 generates a target trajectory for tracking the end vehicle m_{END} (that is, the preceding vehicle) at the final of the congestion vehicle queue based on the tracking travel event. In response to this, based on the target trajectory, the second controller 160 allows the own vehicle M to track the preceding vehicle by controlling at least the speed of the own vehicle M so that an inter-vehicle distance between the own vehicle M and the preceding vehicle is constant (step S120). Then, the process of the flowchart ends.

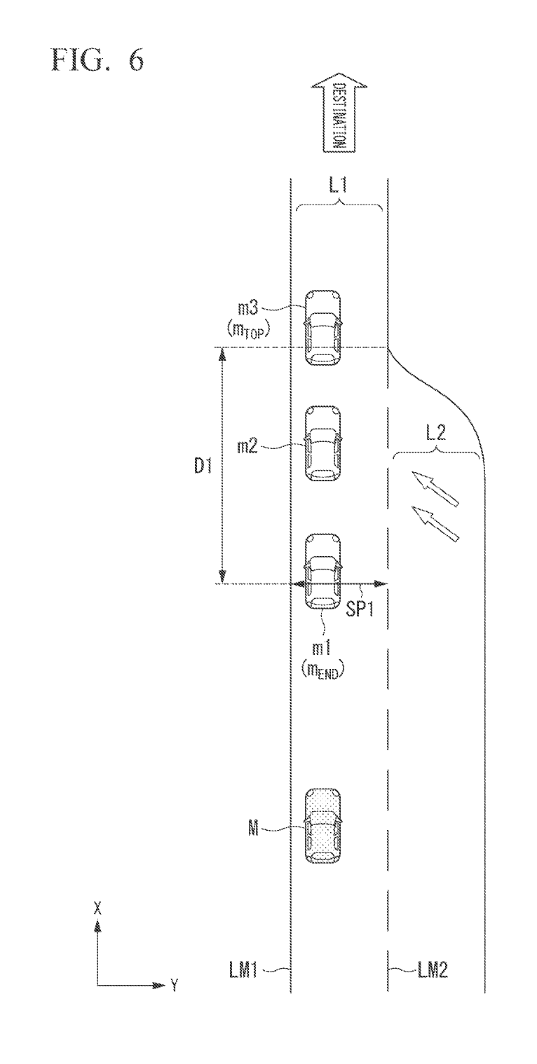

FIG. 6 is a diagram showing a second scenario in which the own vehicle does not overtake the congestion vehicle queue up to the predetermined position SP1. The scenario shown in FIG. 6 is a scenario from a different viewpoint in the same place as that of FIG. 5. In the shown example, the position of the forefront vehicle m_{TOP} of the congestion vehicle queue is more away from the own vehicle M than the predetermined position SP1 in the traveling direction X. In this case, when the own vehicle M overtakes the congestion vehicle queue in the adjacent lane and then returns to the original lane, it is necessary to temporarily stop near the predetermined position SP1 of the adjacent lane, to be allowed to join to the congestion vehicle queue, or waits until the congestion vehicle queue passes. This operation is inefficient and the degree of difficulty of control is high. Therefore, the event determiner 142 decides to stop overtaking the congestion vehicle queue and plans the tracking travel event. In response to this, the target trajectory generator 144 generates a target trajectory in accordance with the tracking travel event and the second controller 160 controls at least the speed of the own vehicle M based on the target trajectory. In this way, the own vehicle M tracks the end vehicle m_{END} of the congestion vehicle queue.

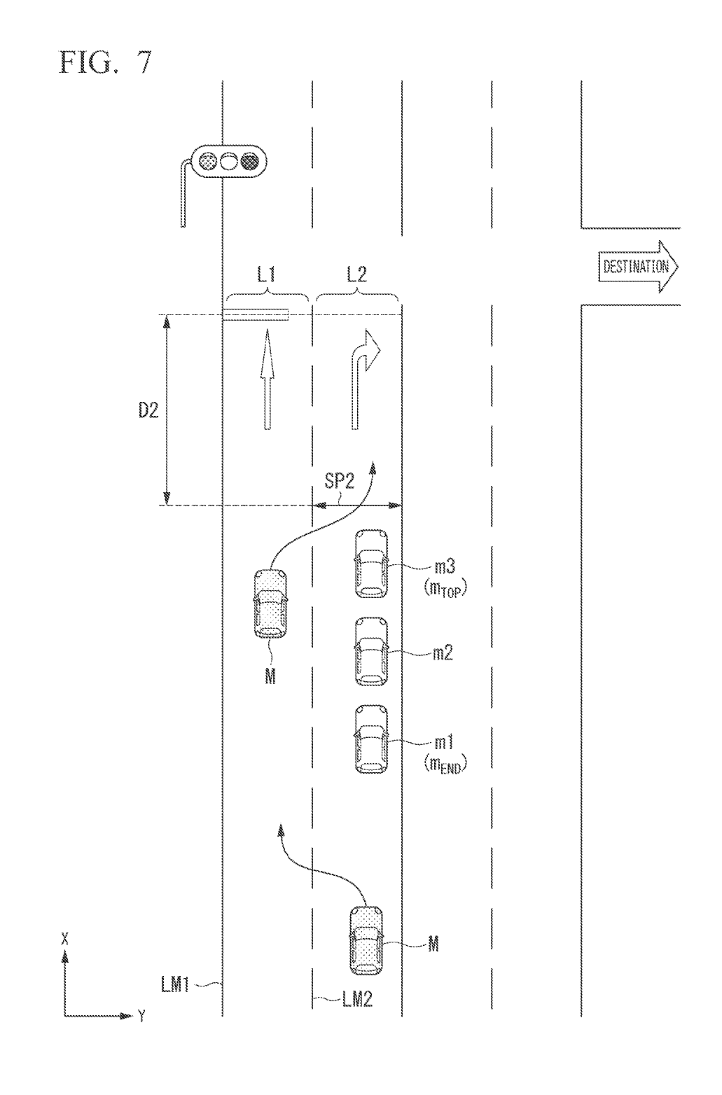

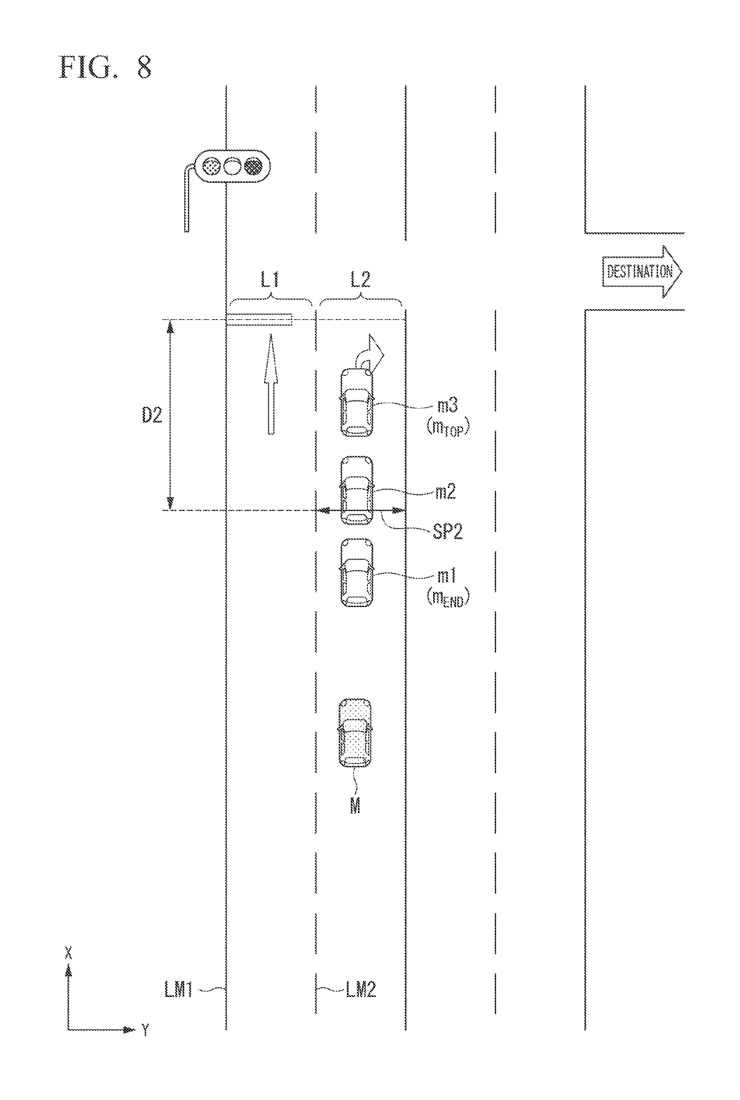

Hereinafter, other scenarios of cases in which the determiner 146 determines a relation between the forefront vehicle m_{TOP} of the congestion vehicle queue and the predetermined position SP in step S112 will be described. FIG. 7 is a diagram showing a third scenario in which the own vehicle M overtakes a congestion vehicle queue up to the predetermined position SP2. FIG. 8 is a diagram showing a fourth scenario in which the vehicle does not overtake the congestion vehicle queue up to the predetermined position SP2. The scenario shown in FIG. 8 is a scenario from a different viewpoint in the same place as that of FIG. 7. In FIGS. 7 and 8, L1 indicate an adjacent lane and L2 indicates the own lane. L1 is a straight-advancing lane and L2 is a right-turn lane.

In the example shown in FIG. 7, the position of the forefront vehicle m_{TOP} of the congestion vehicle queue is closer to the own vehicle M than the predetermined position SP2 in the traveling direction X. In this case, when the own vehicle M overtakes the congestion vehicle queue in the adjacent lane and then returns to the original lane (in this example, the right-turn lane) before the predetermined position SP2, the own vehicle M can travel smoothly without temporarily stopping near the predetermined position SP2. Accordingly, the determiner 146 determines that the own vehicle M can overtake the congestion vehicle queue in front of the own vehicle M in the adjacent lane and can then return to the original lane again. In response to this, the event determiner 142 plans the overtaking event, the target trajectory generator 144 generates a target trajectory in accordance with the overtaking event, and the second controller 160 controls the speed and steering of the own vehicle M based on the target trajectory. In this way, the own vehicle M overtakes the congestion vehicle queue.

In the example shown in FIG. 8, the position of the forefront vehicle m_{TOP} of the congestion vehicle queue is more away from the own vehicle M than the predetermined position SP2 in the traveling direction X. In this case, when the own vehicle M overtakes the congestion vehicle queue in the adjacent lane and then returns to the right-turn lane, it is necessary to temporarily stop near the predetermined position SP2 of the straight-advancing lane, to be allowed to join to the congestion vehicle queue, or wait until the congestion vehicle queue passes. This operation obstacles traveling of other vehicles that are traveling in back of the own vehicle M in the straight-advancing lane. Therefore, the event determiner 142 decides to stop overtaking the congestion vehicle queue and plans the tracking travel event. In response to this, the target trajectory generator 144 generates a target trajectory in accordance with the tracking travel event and the second controller 160 controls at least the speed of the own vehicle M based on the target trajectory. In this way, the own vehicle M tracks the end vehicle m_{END} of the congestion vehicle queue.

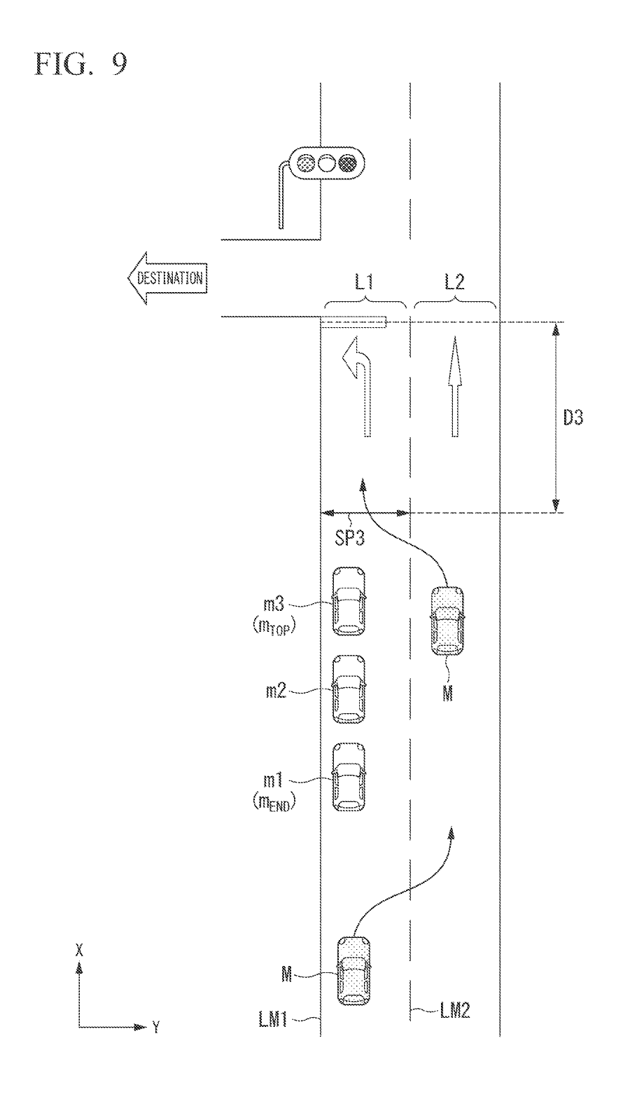

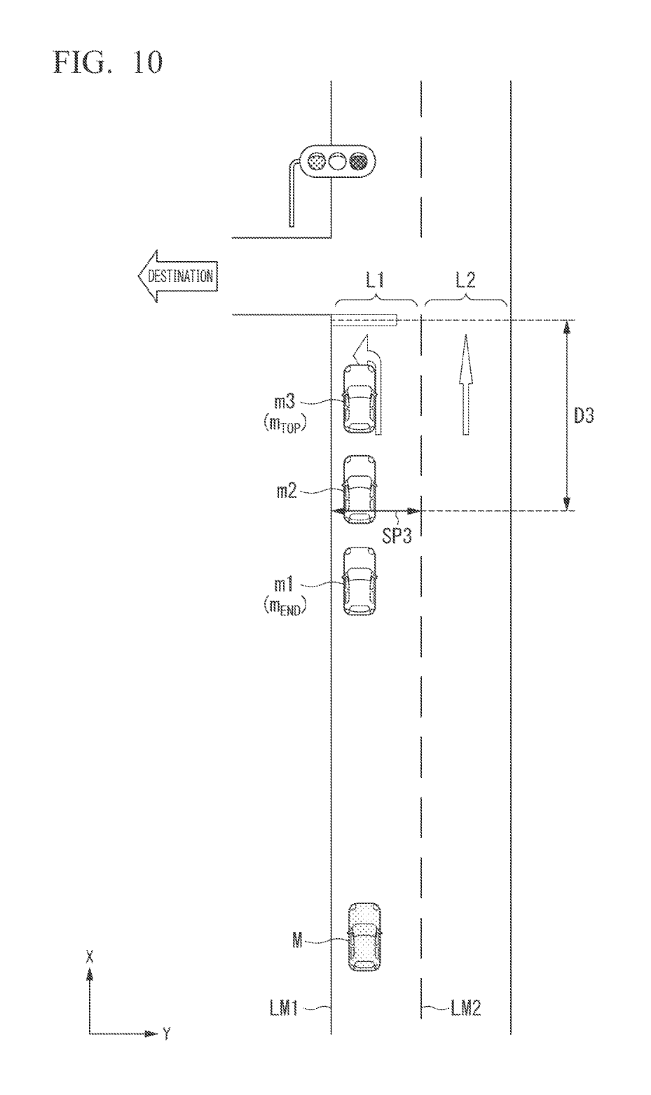

FIG. 9 is a diagram showing a fifth scenario in which the vehicle overtakes a congestion vehicle queue up to a predetermined position SP3. FIG. 10 is a diagram showing a sixth scenario in which the vehicle does not overtake the congestion vehicle queue up to the predetermined position SP3. The scenario shown in FIG. 10 is a scenario from a different viewpoint in the same place as that of FIG. 9. In FIGS. 9 and 10, L1 indicate the own lane and L2 indicates an adjacent lane. L1 is a left-turn lane and L2 is a straight-advancing lane.

In the example shown in FIG. 9, the position of the forefront vehicle m_{TOP} of the congestion vehicle queue is closer to the own vehicle M than the predetermined position SP3 in the traveling direction X. In this case, when the own vehicle M overtakes the congestion vehicle queue in the adjacent lane and then returns to the original lane (in this example, the left-turn lane) before the predetermined position SP3, the own vehicle M can travel smoothly without temporarily stopping near the predetermined position SP3. Accordingly, the determiner 146 determines that the own vehicle M can overtake the congestion vehicle queue in front of the own vehicle M and can then return to the original lane. In response to this, the event determiner 142 plans the overtaking event, the target trajectory generator 144 generates a target trajectory in accordance with the overtaking event, and the second controller 160 controls the speed and steering of the own vehicle M based on the target trajectory. In this way, the own vehicle M overtakes the congestion vehicle queue.

In the example shown in FIG. 10, the position of the forefront vehicle m_{TOP} of the congestion vehicle queue is more away from the own vehicle M than the predetermined position SP3 in the traveling direction X. In this case, when the own vehicle M overtakes the congestion vehicle queue in the straight-advancing lane and then returns to the left-turn lane, it is necessary to temporarily stop near the predetermined position SP3 of the straight-advancing lane, to be allowed to join to the congestion vehicle queue, or waits until the congestion vehicle queue passes. This operation obstacles traveling of other vehicles traveling in back of the own vehicle M in the straight-advancing lane. Therefore, the event determiner 142 decides to stop overtaking the congestion vehicle queue and plans the tracking travel event. In response to this, the target trajectory generator 144 generates a target trajectory in accordance with the tracking travel event and the second controller 160 controls at least the speed of the own vehicle M based on the target trajectory. In this way, the own vehicle M tracks the end vehicle m_{END} of the congestion vehicle queue.

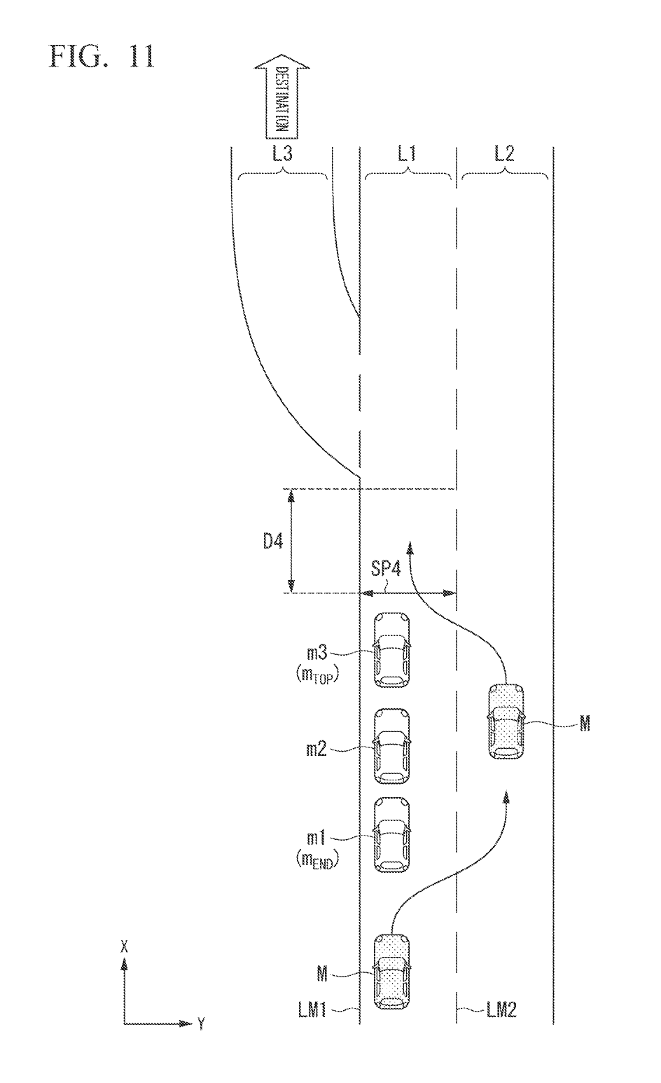

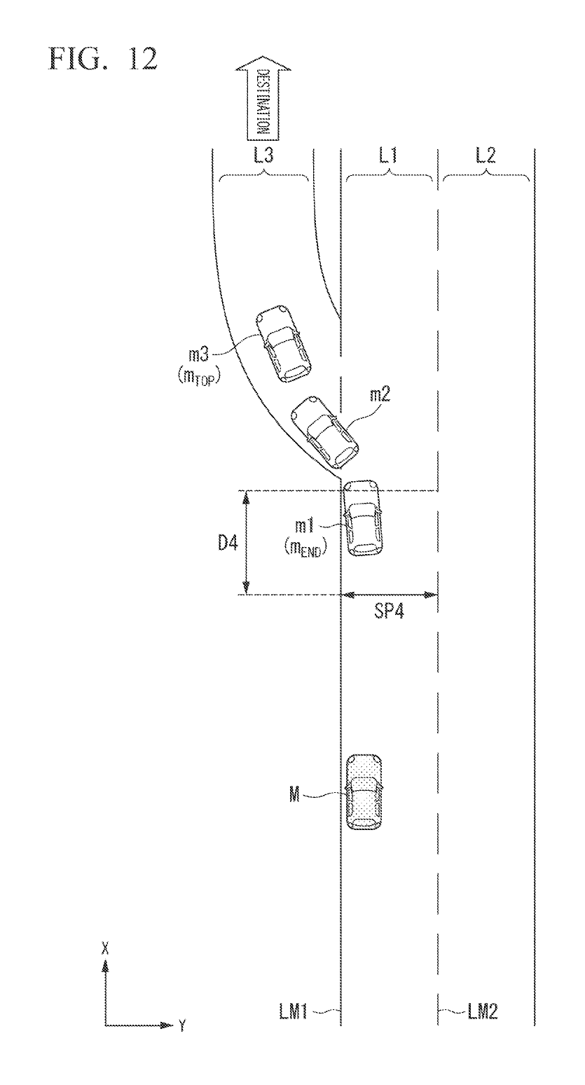

FIG. 11 is a diagram showing a seventh scenario in which the vehicle overtakes a congestion vehicle queue up to a predetermined position SP4. FIG. 12 is a diagram showing an eighth scenario in which the vehicle does not overtake the congestion vehicle queue up to the predetermined position SP4. The scenario shown in FIG. 12 is a scenario from a different viewpoint in the same place as that of FIG. 11. In FIGS. 11 and 12, L1 indicate the own lane, L2 indicates an adjacent lane, L3 indicates a branching lane.

In the example shown in FIG. 11, the position of the forefront vehicle m_{TOP} of the congestion vehicle queue is closer to the own vehicle M than the predetermined position SP4 in the traveling direction X. In this case, when the own vehicle M overtakes the congestion vehicle queue in the adjacent lane and then returns to the original lane (in this example, the own lane L1) before the predetermined position SP4, the own vehicle M can travel smoothly without temporarily stopping near the predetermined position SP4. Accordingly, the determiner 146 determines that the own vehicle M can overtake the congestion vehicle queue in front of the own vehicle M in the adjacent lane and can then return to the original lane. In response to this, the event determiner 142 plans the overtaking event, the target trajectory generator 144 generates a target trajectory in accordance with the overtaking event, and the second controller 160 controls the speed and steering of the own vehicle M based on the target trajectory. In this way, the own vehicle M overtakes the congestion vehicle queue.

In the example shown in FIG. 12, the position of the forefront vehicle m_{TOP} of the congestion vehicle queue is more away from the own vehicle M than the predetermined position SP4 in the traveling direction X. In this case, when the own vehicle M overtakes the congestion vehicle queue in the adjacent lane and then returns to the own lane, it is necessary to temporarily stop near the predetermined position SP4 of the adjacent lane, to be allowed to join to the congestion vehicle queue, or wait until the congestion vehicle queue passes. In this case, the own vehicle M obstacles traveling of other vehicles that are traveling in back of the own vehicle M in the adjacent lane. Accordingly, the event determiner 142 decides to stop overtaking the congestion vehicle queue and plans the tracking travel event. In response to this, the target trajectory generator 144 generates a target trajectory in accordance with the tracking travel event and the second controller 160 controls at least the speed of the own vehicle M based on the target trajectory. In this way, the own vehicle M tracks the end vehicle m_{END} of the congestion vehicle queue.

According to the above-described embodiment, there are provided the recognizer 130 that recognizes a surrounding situation of the own vehicle M and the second controller 160 that is a controller controlling acceleration, deceleration, and steering of the own vehicle M based on a recognition result of the recognizer 130 and allows the own vehicle M to overtake a plurality of preceding vehicles in front of the own vehicle M in the own lane in which the own vehicle M is present when the plurality of preceding vehicles are congested in a row and a position of the foremost preceding vehicle is closer to the own vehicle M than the predetermined position SP to which the own vehicle is scheduled to travel. It is possible to determine whether to overtake a vehicle in front depending on a surrounding situation.

### [Hardware Configuration]

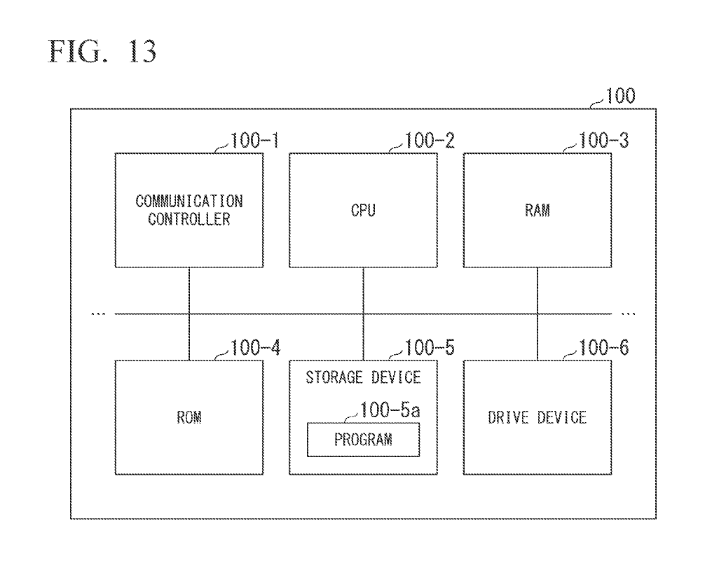

FIG. 13 is a diagram showing an example of a hardware configuration of the automatic driving control device 100 according to the embodiment. As shown, the automatic driving control device 100 is configured such that a communication controller 100-1, a CPU 100-2, a RAM 100-3 that is used as a working memory, a ROM 100-4 that stores a boot program or the like, a storage device 100-5 such as a flash memory or an HDD, a drive device 100-6, and the like are connected to each other via an internal bus or a dedicated communication line. The communication controller 100-1 performs communication with constituent element other than the automatic driving control device 100. The storage device 100-5 stores a program 100-5a that is executed by the CPU 100-2. The program is loaded on the RAM 100-3 by a direct memory access (DMA) controller (not shown) to be executed by the CPU 100-2. Thus, one or both of the first controller 120 and the second controller 160 are realized.

The above-described embodiment can be expressed as follows.

A vehicle control device includes a storage configured to store a program and a processor. By causing the process to execute the program, the processor recognizes a surrounding situation of an own vehicle, controls acceleration, deceleration, and steering of the own vehicle based on a recognition result, determines whether the plurality of preceding vehicles are congested in a row in front of the own vehicle in an own line in which the own vehicle is present and a position of the foremost preceding vehicle among the plurality of preceding vehicles is in front of a predetermined position to which the own vehicle is scheduled to travel when the overtaking by the own vehicle is allowed by the changing the lane, and does not allow the own vehicle to overtake the plurality of preceding vehicles when it is determined that the plurality of preceding vehicles are congested in a row and the position of the foremost preceding vehicle is in front of the predetermined position.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognizer configured to recognize a surrounding situation of an own vehicle; and
a driving controller configured to control acceleration, deceleration and steering of the own vehicle based on a recognition result of the recognizer and allowing the own vehicle to overtake a plurality of preceding vehicles in front of the own vehicle in an own lane in which the own vehicle is present when the plurality of preceding vehicles are congested in a row and a position of the foremost preceding vehicle among the plurality of preceding vehicles is closer to the own vehicle than a predetermined position to which the own vehicle is scheduled to travel.

2. The vehicle control device according to claim 1, wherein the predetermined position is a position at which the own vehicle overtakes the plurality of preceding vehicles congested in a row by changing a lane and then preferably returns to the original lane to travel along a route in which the own vehicle is scheduled to travel.

3. The vehicle control device according to claim 2, wherein the predetermined position is a position in front of a position at which a plurality of lanes are joined into one side lane, and is a position in a lane which is a main lane after the joining.

4. The vehicle control device according to claim 2, wherein the predetermined position is a position in front of an intersection at which an instruction to turn right is given along the scheduled route and a position in a lane in which a right turn is possible, or a position in front of an intersection at which an instruction to turn left is given along the scheduled route and a position in a lane in which a left turn is possible.

5. The vehicle control device according to claim 1,
wherein the driving controller is configured to control a speed and steering of the own vehicle to move the own vehicle from a middle of a lane to a position biased to a right or left mark line side in a lane width direction, and
wherein the recognizer is configured to recognize a position of the foremost preceding vehicle after the own vehicle is moved to the position biased from the middle of the lane by the driving controller.

6. The vehicle control device according to claim 5, wherein the driving controller is configured to determine whether the position of the foremost preceding vehicle recognized by the recognizer is in front of the predetermined position.

7. A vehicle control method causing a computer to perform:
recognizing a surrounding situation of an own vehicle; and
controlling acceleration, deceleration and steering of the own vehicle based on a recognition result and allowing the own vehicle to overtake a plurality of preceding vehicles in front of the own vehicle in an own lane in which the own vehicle is present when the overtaking by the own vehicle is allowed, the plurality of preceding vehicles are congested in a row, and a position of the foremost preceding vehicle among the plurality of preceding vehicles is closer to the own vehicle than a predetermined position to which the own vehicle is scheduled to travel.

8. A storage medium causing a computer to perform:
a process of recognizing a surrounding situation of an own vehicle; and
a process of controlling acceleration, deceleration and steering of the own vehicle based on a recognition result and allowing the own vehicle to overtake a plurality of preceding vehicles in front of the own vehicle in an own lane in which the own vehicle is present when the overtaking by the own vehicle is allowed, the plurality of preceding vehicles are congested in a row, and a position of the foremost preceding vehicle among the plurality of preceding vehicles is closer to the own vehicle than a predetermined position to which the own vehicle is scheduled to travel.
